(19) United States
(12) Patent Application Publication
(10) Pub. No.: US 2008/0200197 A1
(43) Pub. Date: Aug. 21, 2008

(54) Method For Operating a Radio Communications System

(76) Inventors: Christina Gessner, Munchen (DE); Jean-Michel Traynard, Munchen (DE)

Correspondence Address: STAAS & HALSEY LLP, SUITE 700, 1201 NEW YORK AVENUE, N.W., WASHINGTON, DC, 20005, US

(21) Appl. No.: 10/555,884

(22) PCT Filed: Mar. 25, 2004
(86) PCT No.: PCT/EP2004/003187

§ 371 Date: Feb. 7, 2008

(30) Foreign Application Priority Data
May 7, 2003 (DE) 103 20 418.0

(51) Int. Cl. H04B 7/005

(52) U.S. Cl. 455/517

(57) ABSTRACT

A data service is provided in which a network-side radio station emits data, which can be received by at least one subscriber's station without a logical connection being set up between the subscriber's station and the network-side radio station. Radio parameters for emitting the data are set according to features of subscriber's stations located within an area assigned to the network-side radio station. The network-side radio station obtains the items of information concerning the subscriber's station located within the area and items of information concerning the features of these subscriber's stations, in particular, from a higher-ranking network unit.

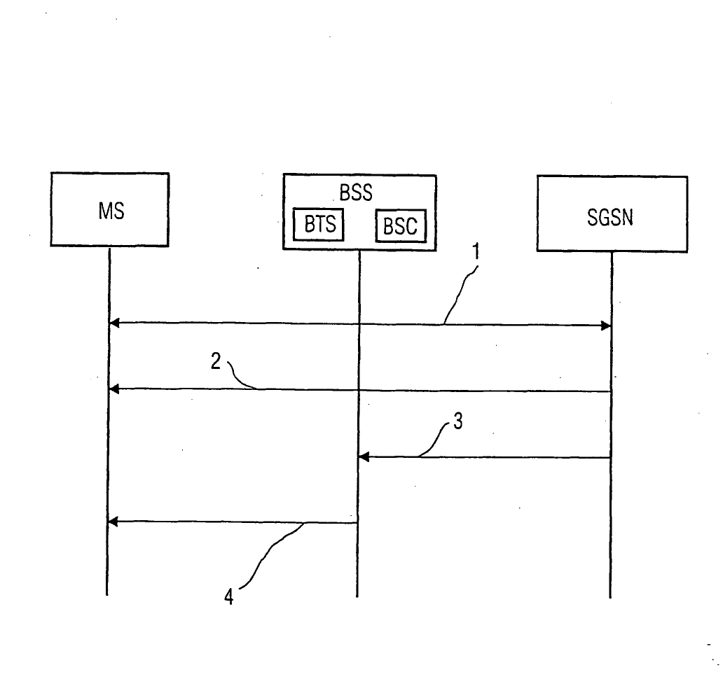

### CROSS REFERENCE TO RELATED APPLICATIONS

This application is based on and hereby claims priority to PCT Application No. PCT/EP2004/003187 filed on Mar. 25, 2004 and German Application No. 10320418.0 filed on May 7, 2003 the contents of which are hereby incorporated by reference.

### BACKGROUND OF THE INVENTION

The invention relates to a method for operating a radio communication system, in particular a mobile radio system.

Radio communication systems are used for transferring information, voice or data with the aid of electromagnetic waves via a radio interface between a sending radio station and a receiving radio station. An example of a radio communication system is the well-known GSM mobile radio network and its development GPRS, whose architecture is described in B. Walke, Mobilfunknetze und ihre Protokolle, Volume 1, Teubner Verlag, Stuttgart, 1998, Pages 139 to 151 and Pages 295 to 311, for example. In this case, a channel is provided for transmitting a subscriber signal, said channel being formed in each case by a narrow-band frequency range and a timeslot.

For the purpose of packet data switching, a radio communication system such as a GSM mobile radio network with GPRS, for example, includes a multiplicity of packet data service nodes (Serving GPRS Support Node SGSN) which are inter-networked and provide the access to a fixed data network. For the purpose of line-switched data transmission, the radio communication system includes mobile switching centers which are inter-networked and provide the access to a fixed data network. The packet data service nodes and the mobile switching centers are also connected to base station controllers (BSC). Each base station controller allows a connection to at least one base station (BTS) and undertakes the management of the radio-technical resources of the connected base stations. Base stations and base station controllers are referred to as base station systems. A base station is a sending/receiving unit which is capable of establishing a message connection to subscriber stations via a radio interface.

A distinction is made between two operating modes of a subscriber station: In the “idle mode”, this being the usual term among experts, no logical connection exists between the subscriber station and a base station. In the “dedicated mode”, this term being likewise usual, a logical connection exists between the subscriber station and a base station, wherein the subscriber station is assigned a dedicated channel via which a message transmission can take place.

New types of data services have been proposed in which a radio station, e.g. a base station, transmits data without said data being assigned to a specific connection. Instead, the data is sent in the sense of a radio broadcast and can be received by all subscriber stations, in particular within the transmission range of the base station, or a defined group of subscriber stations in the radio communication system. The receiving subscriber stations might be in the idle mode in this case. These services include the so-called “Multimedia Broadcast Multicast Service” (“MBMS”) which is proposed for the GERAN and UTRAN standards. Concerning this, reference is made by way of example to the following technical specifications: 3GPP TR 25.992, V1.2.0 (2003-01) “Multimedia Broadcast Multicast Service (MBMS); UTRAN/GERAN Requirements”, TR 23.846, V6.1.0 (2002-12) “MBMS; Architecture and functional description (Release 6)”, and TS 22.146, V6.1.0 (2002-09) “MBMS; Stage 1 (Release 6)”.

Potential subscribers to such data services can have themselves registered in the radio communication system. They are then given an identification code and can be assigned as a group to specific signaling channels, e.g. as a paging group to a paging channel. The accounting for these services takes place via the registration.

In the context of these data services, the data is transmitted exclusively by a radio station which is on the network side. Since no dedicated connection is established between potential subscribers of the data service and the network-side radio station, no information relating to the facilities of the subscriber stations which are participating in the data service is usually available to the network-side radio station. Therefore the transmission of the data must be configured by the network-side radio station in such a way that receipt is possible for all subscriber stations. The configuration must therefore be geared towards the minimal facilities of subscriber stations which can be operated in the radio communication system. Facilities of subscriber stations having greater complexity, said facilities extending beyond the minimal facilities, can only be taken into consideration in the context of a dedicated point-to-point connection, which should not be used for such data services due to the required radio resources.

### SUMMARY OF THE INVENTION

One aspect of the invention addresses the problem of specifying a method for operating a radio communication system in which subscriber station facilities that extend beyond a minimal configuration can be taken into consideration for data services in which a network-side radio station transmits data without this data being assigned to a specific connection.

The inventors propose a data service in which a network-side radio station transmits data which can be received by at least one subscriber station, without a logical connection being established between the subscriber station and the network-side radio station. The network-side radio station is designed as a base station (BSS: Base Station System), for example. Short video clips, for example, are transmitted via the data service. The data service is usually received by more than one subscriber station. The transmission of the data takes place in the form of a radio broadcast transmission. The radio parameters for the transmission of the data are set depending on the facilities of subscriber stations which are located in an area that is assigned to the network-side radio station.

Within the method, consideration is therefore given to which facilities are supported by subscriber stations that are actually potential subscribers to the data service because they are located in the area which is assigned to the network-side radio station. Subscriber stations which are located outside of this area and which possibly support fewer facilities are not taken into consideration when the radio parameters are set. The transmission of the data can therefore take place using the radio parameters which can be supported by the subscriber stations that are located in the area and have the poorest or fewest facilities. The facilities relate to different modulation or encoding procedures, for example, or the property which enables subscriber stations to receive data over more than one time slot, this being commonly referred to by experts as multislot functionality.

An advantage of the proposed method is that subscriber stations having advanced facilities are also able to utilize these facilities to the greatest possible extent. Information which is needed by the base station system for this purpose is provided within the radio communication system, without the signaling traffic on the air interface between the subscriber station and base station system being burdened by said information.

Information about the subscriber stations which are located in the area that is assigned to the network-side radio station and information about the facilities of these subscriber stations is preferably present in a network unit which is hierarchically higher than the network-side radio station. The hierarchically higher network unit then sends the network-side radio station a message, with reference to which the network-side radio station sets the radio parameters for the transmission of the data.

The hierarchically higher network unit corresponds to a packet data switching unit as provided by a so-called SGSN in a radio communication system which is structured according to the GERAN standard or as per the UTRAN standard. So-called routing information for all subscriber stations which are located in a so-called routing area is collected in the packet data switching unit. This routing information can be used in order to specify the subscriber stations which are located in the area that is assigned to the network-side radio station. In this case, it is advantageous if the area which is assigned to the network-side radio station corresponds to the routing area. However, the area which is assigned to the network-side radio station can also concern only a part of the routing area, e.g. a radio cell, which is served by the network-side radio station.

This message is preferably transferred before radio resources for the data service are assigned in the network-side radio station. This can take place as part of the MBMS Radio Access Bearer setup which is provided in the UTRAN standard or as part of the PFC (Packet Flow Context) setup which is provided in the GERAN standard.

In accordance with the proposed configuration, the message which is transferred from the hierarchically higher network unit to the network-side radio station contains the information about the facilities of all subscriber stations that are located in the area. In this case, an analysis of this information takes place in the network-side radio station, thereby establishing which minimal combination of facilities is supported by all subscriber stations located in the area. This minimal combination of facilities is then provided as a basis when setting the radio parameters for the transmission of the data service.

In accordance with a further embodiment, a minimal combination of facilities which is supported by all subscriber stations located in the area is determined in the hierarchically higher network unit. In this case, the message to the network-side radio station only contains information about the minimal combination of facilities. This approach has the advantage that less data is transmitted between the hierarchically higher network unit and the network-side radio station, and that the processor of the network-side radio station is not burdened with this analysis.

The hierarchically higher network unit holds information about the registration of the relevant subscriber station for participation in the data service, and the hierarchically higher network unit receives the information about the facilities of the subscriber station during the registration of the subscriber station.

Alternatively, in the event of a location change, the subscriber station sends the hierarchically higher network unit a report containing the information about the facilities of the subscriber station. This can take place, for example, within the context of reports which are provided in any case for the exchange of the routing information as per the GERAN standard or UTRAN standard.

The radio parameters for the transmission of the data service are preferably changed if the number of subscriber stations located in the area changes. If a subscriber station leaves the area, therefore, a check is performed in order to determine whether the minimal combination of facilities which was provided as a basis when setting the radio parameters still corresponds to the current minimal combination of facilities of the remaining subscriber stations in the area. If the subscriber station having the most restricted combination of facilities has left the area, for example, a resetting of the radio parameters takes place in accordance with the now current minimal combination of facilities which is supported by the remaining subscriber stations. Conversely, if a subscriber station is added, a check is performed in order to determine whether this subscriber station supports all the facilities included in the minimal combination of facilities which was provided as a basis for the current setting of the radio parameters. If the newly arrived subscriber station supports fewer facilities than are included in the current minimal combination of facilities, an updated combination of facilities is specified and provides a basis for resetting the radio parameters for the transmission of the data service. This ensures that the newly arrived subscriber station can also receive the data service.

If the information about the subscriber stations located in the area and their facilities is managed in the hierarchically higher network unit, it is advantageous to notify the network-side radio station about this information regularly or each time there is a change.

### BRIEF DESCRIPTION OF THE DRAWINGS

These and other objects and advantages of the present invention will become more apparent and more readily appreciated from the following description of the preferred embodiments, taken in conjunction with the accompanying drawing of which:

The FIGURE shows an exchange of messages when establishing a transmission of a data service.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

One or more subscriber stations MS, a base station system BSS comprising a base station controller BSC and a base station BTS, and a packet data switching unit SGSN participate in the data service, e.g. an MBMS. A registration 1 of the subscriber station MS at the packet data switching unit SGSN takes place first. The registration 1 includes, for example, the extent of the data which is to be received in the context of the data service, information which relates to the subscriber station and is required for accounting in relation to the data service, and information about facilities which the subscriber station MS supports. The registration 1 normally takes place independently of a current transmission in the context of the data service. The registration 1 normally takes place between a multiplicity of subscriber stations MS and the packet data switching unit SGSN.

At the beginning of a transmission of data in the context of the data service, an announcement 2 takes place by which the intended transmission is identified by the packet data switching unit SGSN via a broadcast channel. The announcement 2 can be received by all subscriber stations MS located in the transmission range of the SGSN, such that potential subscribers can configure themselves to receive the data.

The packet data service unit SGSN sends a message 3 to the base station system BSS, containing information about the subscriber stations MS located in an area which is assigned to the base station system BSS and information about the facilities of these subscriber stations MS. The message 3 contains, for example, the minimal combination of facilities supported by all subscriber stations MS located in the area.

The information indicating which subscriber stations MS are located in the area is obtained by the packet data switching unit SGSN from the routing information which is routinely sent in accordance with the GERAN or UTRAN standard.

On the basis of the minimal combination of facilities which is taken from the message 3, the base station controller BSC within the base station system BSS sets radio parameters which are used for a subsequent transmission 4 of the data from the base station system BSS to potential participating subscriber stations MS.

If a subscriber station MS leaves the area which is assigned to the base station system BSS, the packet data switching unit SGSN receives information about this location change. Consequently, an updated minimal combination of facilities is specified in the packet data switching unit SGSN and transferred to the base station system BSS via a further message. If the updated minimal combination of facilities and the previously used minimal combination of facilities differ, the base station controller BSC within the base station system BSS resets the radio parameters for the further transmission of the data service.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-9. (canceled)

10. A method for operating a radio communication system, comprising:
transmitting data for a data service from a network-side radio station to a subscriber station, the data being transmitted without a logical connection between the subscriber station and the network-side radio station; and
setting radio parameters for transmission of the data based on communication capabilities of subscriber stations located in an area that is assigned to the network-side radio station.

11. The method as claimed in claim 10,
wherein information about which subscriber stations are located in the area that is assigned to the network-side radio station and information about the communication capabilities of these subscriber stations is available from a network unit which is hierarchically higher than the network-side radio station,
wherein the network unit sends the network-side radio station a message, and
wherein the network-side radio station sets the radio parameters based on the message from the network unit.

12. The method as claimed in claim 11,
wherein the message contains the information about the communication capabilities of the subscriber stations that are located in the area that is assigned to the network-side radio station.

13. The method as claimed in claim 11,
wherein the network unit determines a greatest common communication capability for the subscriber stations that are located in the area that is assigned to the network-side radio station, and
wherein the message contains information about the greatest common communication capability.

14. The method as claimed in 11,
wherein the network unit stores information about which subscriber stations are registered to participate in the data service, and
wherein the network unit receives the information about the communication capabilities of the subscriber stations when the subscriber stations register.

15. The method as claimed in claim 11,
wherein, if a new subscriber station moves into the area that is assigned to the network-side radio station, then the new subscriber station sends the network unit a report identifying the communication capabilities of the new subscriber station.

16. The method as claimed in claim 10,
wherein the radio parameters for the transmission of the data are changed if the number of subscriber stations which are located in the area changes.

17. The method as claimed in claim 10, wherein the data is transmitted to a plurality of subscriber stations.

18. The method as claimed in 13,
wherein the network unit stores information about which subscriber stations are registered to participate in the data service, and
wherein the network unit receives the information about the communication capabilities of the subscriber stations when the subscriber stations register.

19. The method as claimed in claim 18,
wherein the radio parameters for the transmission of the data are changed if the number of subscriber stations which are located in the area changes.

20. The method as claimed in claim 13,
wherein, if a new subscriber station moves into the area that is assigned to the network-side radio station, then the new subscriber station sends the network unit a report identifying the communication capabilities of the new subscriber station.

21. The method as claimed in claim 20,
wherein the radio parameters for the transmission of the data are changed if the number of subscriber stations which are located in the area changes.

22. A system for operating a radio communication system, comprising:
a network-side radio station to transmit data for a data service to a subscriber station which is located in an area that is assigned to the network-side radio station; and
a device to set radio parameters for transmission of the data, the radio parameters being set based on communication capabilities of subscriber stations that are located in said area, the data being transmitted without a logical connection between the subscriber station and the network-side radio station.

23. The system as claimed in claim 22, wherein the network-side radio station is base station and the device to set radio parameters is a base station controller.
